(19) United States
(12) Patent Application Publication
(10) Pub. No.: US 2005/0010764 A1
(43) Pub. Date: Jan. 13, 2005

(54) System and method for securely transmitting, and improving the transmission of, tag based protocol files containing proprietary information

(75) Inventors: Jean-Luc Collet, La Gaude (FR); Bernard Dakar, St Laurent du Var (FR); Gerard Marmigere, Drap (FR); Joaquin Picon, St Laurent du Var (FR)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/874,596

(22) Filed: Jun. 23, 2004

(30) Foreign Application Priority Data
Jun. 26, 2003 (EP) 03368059.6
Jun. 26, 2003 (EP) 03368060.4

(51) Int. Cl. H04L 9/32

(52) U.S. Cl. 713/165

(57) ABSTRACT

A system and a method for securely transmitting a tag based protocol file comprising proprietary data from a Web Server to a Client Web Browser. The proprietary data is extracted from the tag based protocol file, locally stored and replaced by references and/or calls to a data insert function. The modified tag based protocol file may be sent according to a standard communication protocol. The Client Web Browser can send a request to the Web Server for retrieving extracted proprietary data, which is transmitted by the Web Server according to a secure communication protocol. The proprietary data may also be extracted from the tag based protocol files, encrypted and replaced by calls to data insert functions whose parameters are decryption functions having encrypted data as parameters. Calls to a data insert function associated with the decryption function allow the Client Web Browser to send a request to the Web Server for the decryption key. The request for the decryption key and its transfer are done according to a secure communication protocol.

### COPYRIGHT NOTICE

A portion of the disclosure of this patent document contains material which is subject to copyright protection. The copyright owner has no objection to the facsimile reproduction by anyone of the patent disclosure, as it appears in the United States Patent and Trademark Office patent file or records, but otherwise reserves all copyright rights whatsoever.

### FIELD OF THE INVENTION

The present invention relates generally to transfer of documents over nonsecure networks, such as the Internet, and more specifically to a system and a method for transmitting tag based protocol files, containing proprietary data, between two computers of a nonsecure network.

### BACKGROUND OF THE INVENTION

Recently, communication between computer systems for data and information exchange has improved significantly thanks to the Internet, which is known to have rapidly spread on a global level by virtue of being supported by public communication networks, both traditional and technologically advanced ones, such as ISDN, ADSL, GPRS, and others. Success of this phenomenon is indeed due, also, to the availability, in real time and cheaply, of information and data stored on servers located all over the globe and connected through dedicated digital lines to computers reachable through the various last mile network access services.

Most of the electronic texts available from the World Wide Web are formatted according to the Hyper Text Markup Language (HTML) standard. Unlike other electronic texts, HTML ‘source’ documents, from which content text is displayed, contain embedded textual tags. HTML is designed to display the data and to focus on how data looks. HTML is based on the Standard Generalized Markup Language (SGML). Similar languages have also been developed for dedicated kinds of applications and/or devices. For example, Wireless Markup Language (WML) is an adaptation of HTML for hand held devices.

Since more and more of the information exchanged on the World Wide Web is accessed by a large variety of devices, such as personal computers, personal digital assistants, and screenphones, data is commonly adapted to the characteristics of the receiving devices, e.g., screen size, font size, and the presence or absence of a Java Virtual Machine (Java is a Registered Trade Mark of Sun Microsystems Inc.). The adaptation concerns the form of the data and not the data itself.

Data adaptation can be done directly by servers. However, most servers are not able to perform such a task. As a consequence, a presentation layer is generally introduced in the infrastructure as a proxy. This layer, also referred to as a transcoding function, is in charge of analyzing the stream from the server to the client so as to adapt data to the client device characteristics. This architecture is used in many servers since it is a very cost effective way of managing access from multiple devices without having to modify the content source. However, a main drawback lies in that on-the-fly transcoding can not handle secured and encrypted streams because data can not be decrypted.

Therefore, since the exchange of information is increasing dramatically over the Internet, there is a need for optimizing the transmission of tag based protocol files containing confidential data.

### SUMMARY OF THE INVENTION

Thus, it is a broad object of the invention to remedy the shortcomings of the prior art as described above.

It is another object of the invention to provide a system and method for transmitting a tag based protocol file comprising confidential data over a nonsecure network, wherein nonconfidential data may be modified by a third-party system.

It is a still another object of the invention to provide a system and method for transmitting a tag based protocol file over a nonsecure network, wherein data may be partially modified by a third-party system.

It is a further object of the invention to provide a system and method for transmitting a tag based protocol file comprising confidential data over a nonsecure network, wherein nonconfidential data may be modified by a third-party system and wherein the amount of data that must be transferred according to a secure protocol is reduced.

The accomplishment of these and other related objects is achieved by a method for securely transmitting a tag based protocol file comprising proprietary data from a server to a client device, the method comprising the steps of:
identifying the proprietary data within the tag based protocol file,
extracting and storing locally the proprietary data;
inserting at least one reference to the locally stored proprietary data in the tag based protocol file to provide a modified tag based protocol file;
transmitting the modified tag based protocol file using a standard communication protocol; and,
upon request of the client device, transmitting the locally stored proprietary data according to a secure communication protocol, the request comprising the at least one reference to the locally stored proprietary data.

It is a further object of the invention to provide a system and method for transmitting a tag based protocol file over a nonsecure network, wherein data may be partially modified by a third-party system and wherein an amount of data that must be transferred according to a secure protocol is reduced when several files are transmitted during a same session.

The accomplishment of these and other related objects is achieved by a method for securely transmitting a tag based protocol file comprising proprietary data from a server to a client device, the method comprising the steps of:
identifying the proprietary data within the tag based protocol file,
extracting and encrypting the proprietary data according to an encryption key;
inserting the encrypted proprietary data in the tag based protocol file to form a modified tag based protocol file;
transmitting the modified tag based protocol file using a standard communication protocol; and,
upon request of the client device, transmitting a decryption key corresponding to the encryption key, according to a secure communication protocol.

Further advantages of the present invention will become apparent to the ones skilled in the art upon examination of the drawings and detailed description. It is intended that any additional advantages be incorporated herein.

### BRIEF DESCRIPTION OF THE DRAWINGS

FIG. 1 depicts the general principle of an embodiment of the invention.

FIG. 2 illustrates an example of the processing of an HTML file according to the embodiment of the invention depicted in FIG. 1.

FIG. 3 shows an algorithm example of the method of the invention.

FIG. 4 depicts the general principle of another embodiment of the invention.

FIG. 5 illustrates an example of the processing of an HTML file according to the embodiment of the invention depicted in FIG. 4.

FIG. 6, comprising FIGS. 6a and 6b, shows an example of the global algorithm used to transmit files containing proprietary data between a Web Server and a Client Web Browser.

FIG. 7 depicts an example of the algorithm that is used to modify an HTML file according to the invention.

### DETAILED DESCRIPTION OF THE PREFERRED EMBODIMENT

According to an embodiment of the invention, confidential, or private, information is extracted from documents, prior to being transmitted. More generally, all data that needs protection (for example: against theft or modifications), is extracted from the documents prior to transmittal. This kind of data comprises (but is not limited to) confidential data, copyright and ownership statements, and data whose integrity must be preserved. For sake of clarity, this kind of data is, hereafter, referred to as proprietary data. Therefore, the modified documents comprising nonproprietary data are transmitted using a standard communication protocol while removed proprietary data is transmitted separately, according to a secure communication protocol. For example, nonproprietary data may be transmitted according to the Hyper Text Transfer Protocol (HTTP) and proprietary data may be transmitted according to the Hyper Text Transfer Protocol Secure sockets (HTTPS), corresponding to the implementation of Secure Sockets Layer (SSL) protocol over HTTP.

For sake of illustration, the following description is based upon the Internet network wherein an HTML file containing proprietary data is transmitted from a Web Server to a Client Web Browser, using HTTP and HTTPS protocols. For sake of illustration, JavaScript (JavaScript is a Registered Trade Mark of Sun Microsystems Inc.), a scripting language interpreted by the Web Browser, allowing simple programming commands to be inserted into HTML documents, is used in conjunction with HTML files. Nevertheless, it must be understood that the method of the invention may be implemented in different environments, with other protocols.

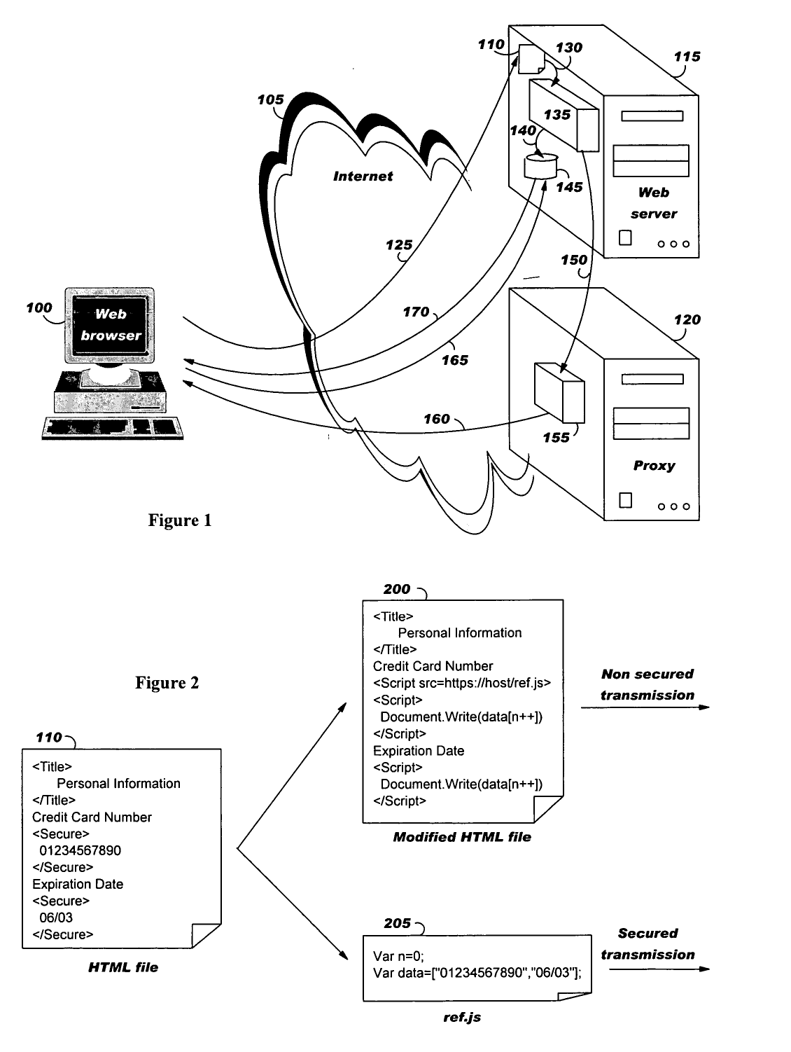

FIG. 1 illustrates the general principle of the method of the invention for transmitting documents containing proprietary information from servers to clients, over unsecured networks. As shown, a Client Web Browser 100 having an access to the Internet network 105 may request a data file 110 stored in a Web Server 115. A proxy 120, comprising a transcoding function, may be used to format the data file 110 according to the Client device. Therefore, the Client Web Browser 100 sends a request (125) for the data file 110 using a standard communication protocol, e.g., HTTP. If the data file 110 is stored in the Web Server 115 in this example, it could naturally be stored in any other storage connected to the Internet network 105. When the requested data file 110 is available (130) in the Web Server 115, it is analyzed in module 135 so as to extract proprietary data. Proprietary data is locally stored (140). For example, proprietary data may be stored in a file on a Web Server hard-drive 145. Proprietary data is replaced in the data file by references that allow the proprietary data to be recovered. In an embodiment of the present invention, proprietary data is replaced in the data file by calls to a data insert function having parameters comprising these references, or a part of these references, so as to allow automatic retrieval and insertion of the proprietary data. For example, the data insert function may be a JavaScript. There are as many references and/or calls to data insert functions as noncontiguous blocks of proprietary data in the HTML file. Then, the modified data file is transmitted (150) to the proxy 120, containing a transcoding module 155 that can adapt the modified data file format to the Client Web Browser characteristics. The adapted modified data file is then transmitted (160) to the Client Web Browser 100 where it can be displayed. As discussed above, the modified data file and the adapted modified data file are transmitted according to a standard communication protocol, e.g., HTTP. The references and/or the function calls inserted in the modified data file, where proprietary data has been removed, are used to recover (165, 170) the proprietary information stored, for example, as a file on hard-drive 145, using a secure connection protocol, e.g., HTTPS.

Thanks to the architecture presented on FIG. 1, it is not required to transmit the complete file with a secure communication protocol but only the proprietary part, the remaining part being transmitted using a standard, nonsecure communication protocol. Therefore, the nonsecure part may be adapted to the target device, as generally done, using, for example, a transcoding function such as IBM Websphere Transcoding Publisher product (Websphere is a Registered Trade Mark of International Business Machines Corporation).

FIG. 2 illustrates an example of the content of an HTML file before and after being modified. According to HTML format, tags are used in the data file 110 to determine the data format. A dedicated tag, referred to as “<Secure>” in this example, and the corresponding ending tag (“</Secure>”), are used to delimit the proprietary data of the data file. Naturally, several noncontiguous portions of the data file may contain proprietary data. In the given example, the proprietary data corresponds to a credit card number and to the associated expiration date. To extract the proprietary data, analyzer module 135 looks for the dedicated tags, “<Secure>” and </Secure> in the given example. When these dedicated tags are found by the analyzer module 135, they are removed and the data located between the tag “<Secure>” and the following corresponding ending tag “</Secure> is locally stored, e.g., in file “ref.js” on a local hard-drive (e.g., drive 145, FIG. 1). The path of the location where this proprietary data is stored, which is necessary to recover the proprietary data, is inserted in the modified HTML file. Likewise, a call to a data insert function allowing recovery of the proprietary data is inserted where the proprietary data has been removed. In the given example, the calls to the data insert function is of the form of a JavaScript and the function parameters are the references of the data to be inserted within the local file containing proprietary data.

When the HTML file has been fully analyzed, all the proprietary data has been removed and replaced by references and/or calls to data insert functions. Therefore, the modified HTML file may be sent according to a nonsecure communication protocol while the file containing only the proprietary data must be sent according to a secure communication protocol. As mentioned above, transmitting the modified HTML file according to a nonsecure communication protocol allows a third-party system, e.g., a proxy, to modify it, for example to adapt it to the client device characteristics.

The example of JavaScript shown on FIG. 2 allows the removed data to be easily recovered by inserting a link to a remote script containing the secure data, e.g., “<script src=https://host/ref.js>”. The structure of this file is a JavaScript table containing all the proprietary data. When parsing the HTML page, the Web Browser retrieves the file containing the proprietary data by opening an HTTPS connection. Therefore, the proprietary data may be inserted in the HTML page. The HTML page contains references to the JavaScript table using an index to retrieve the corresponding proprietary data “Document.Write(data[n++])”. Such coding simplifies the replacement of each proprietary data by a reference to the corresponding data in the remote script that is interpreted during execution. Naturally, there exist many other ways of implementing a JavaScript to handle the function of importing data. The resulting HTML page wherein proprietary data is inserted according to the links is exactly the same as the requested HTML page.

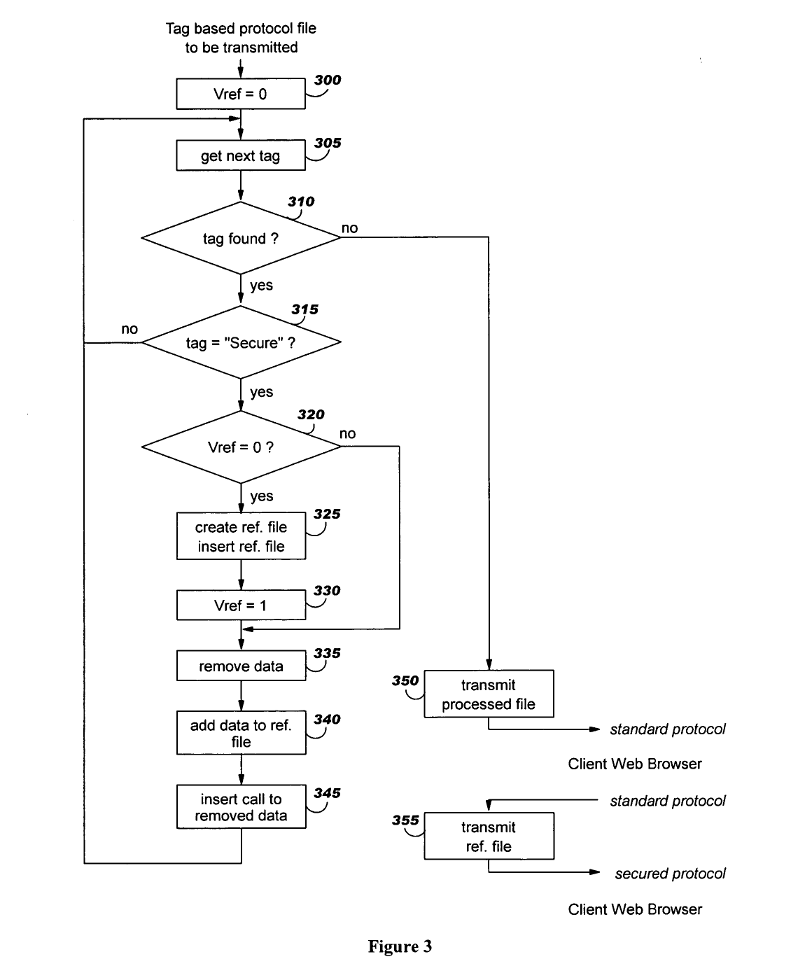

FIG. 3 depicts an example of an algorithm used for extracting proprietary data, inserting calls to a data insert function and associated references, and transmitting the data. When the analyzer module 135 receives the tag based protocol file that is to be transmitted to the Client Web Browser 100, a flag Vref is set to zero (step 300). Flag Vref is used to determine whether or not the local file or variable in which proprietary data is stored has been created and referenced in the analyzed tag based protocol file. Then, according to the tag based protocol, the following tag is obtained (step 305) and a test is performed to determine whether or not a tag is found, i.e., whether or not the end of the file is reached (step 310).

If a tag is found, a second test is done to determine whether or not this tag indicates that following data is proprietary data (step 315). If the tag does not indicate that the following data is proprietary data, the last two steps (steps 305 and 310) are repeated. Else, if the tag indicates that the following data is proprietary data, a third test is performed to analyze the state of flag Vref (step 320). If flag Vref is equal to zero, a file or a variable is locally created to memorize proprietary data, and the path allowing recovery of this file or variable is inserted in the analyzed tag based protocol file (step 325). Then, flag Vref is set to one (box 330). The data located between the found tag and the following corresponding end tag is removed (step 335) and stored in the created file or variable (step 340). Then, a call to a data insert function, having a parameter or reference to the removed proprietary data within the local file or variable, is inserted in the analyzed tag based protocol file (step 345) and the last eight steps (steps 305 to 340) are repeated. If tag Vref is not equal to zero, the process directly branches to step 335 since the file or variable has already been created and the corresponding path has been inserted in the analyzed tag based protocol file.

If no tag is found during step 310, i.e., the end of the file has been reached, the analyzed tag based protocol file is transmitted to the Client Web Browser that sent the request (step 350). As mentioned above, the transmission of the analyzed tag based protocol file to the Client Web Browser is done according to a standard communication protocol such as HTTP.

When the Client Web Browser opens or displays the received analyzed tag based protocol file and detects a reference and/or a call to a data insert function, such as the above mentioned JavaScript, it sends a request to the referenced Web Server in order to recover the removed proprietary data. When receiving such a request, the Web Server establishes a secure connection with the Client Web Browser, e.g., using HTTPS communication protocol, and transmits the requested data (step 355), which is inserted in the received file so that this file appears like the requested file.

According to another embodiment of the invention, confidential, or private, information is encrypted in the document prior to being transmitted. More generally, all data that needs protection (for example: against theft and modifications), is encrypted in the document prior to transmittal. This kind of data comprises (but is not limited to) confidential data, copyright and ownership statements, and data whose integrity must be preserved. For sake of clarity, this kind of data is, hereafter, referred to as proprietary data. Therefore, the modified document may be sent through a standard, nonsecure, communication link, allowing data adaptation comprising, for example, adapting the data to the characteristics of the receiving device. The key used for decrypting encrypted proprietary data is transmitted separately, according to a secure communication protocol. For example, the modified file containing encrypted proprietary data may be transmitted according to the Hyper Text Transfer Protocol (HTTP) and the decryption key may be transmitted according to the Hyper Text Transfer Protocol Secure sockets (HTTPS), corresponding to the implementation of Secure Sockets Layer (SSL) protocol over HTTP. Naturally, the same encryption key may be used to encrypt proprietary data of different files (that are sent to the same receiver). Therefore, since the decryption key needs to be transferred only once, the amount of data that must be transferred according to a secure communication protocol is reduced.

For sake of illustration, the following description is based upon the Internet network wherein HTML files containing proprietary data are transmitted from a Web Server to a Client Web Browser, using HTTP and HTTPS protocols. Also, for sake of illustration, Java Applet and JavaScript (Java and JavaScript are Registered Trade Marks of Sun Microsystems Inc.) are used. A Java Applet is a program written in the Java programming language that can be included in an HTML page. When viewing a page that contains a Java Applet, the Applet's code is transferred from the Web Server to the Client Web Browser and executed by the browser's Java Virtual Machine (JVM). JavaScript, a scripting language interpreted by the Web Browser, allows simple programming commands to be inserted into HTML documents. Nevertheless, it must be understood that the method of the invention may be implemented in different environments, with other protocols.

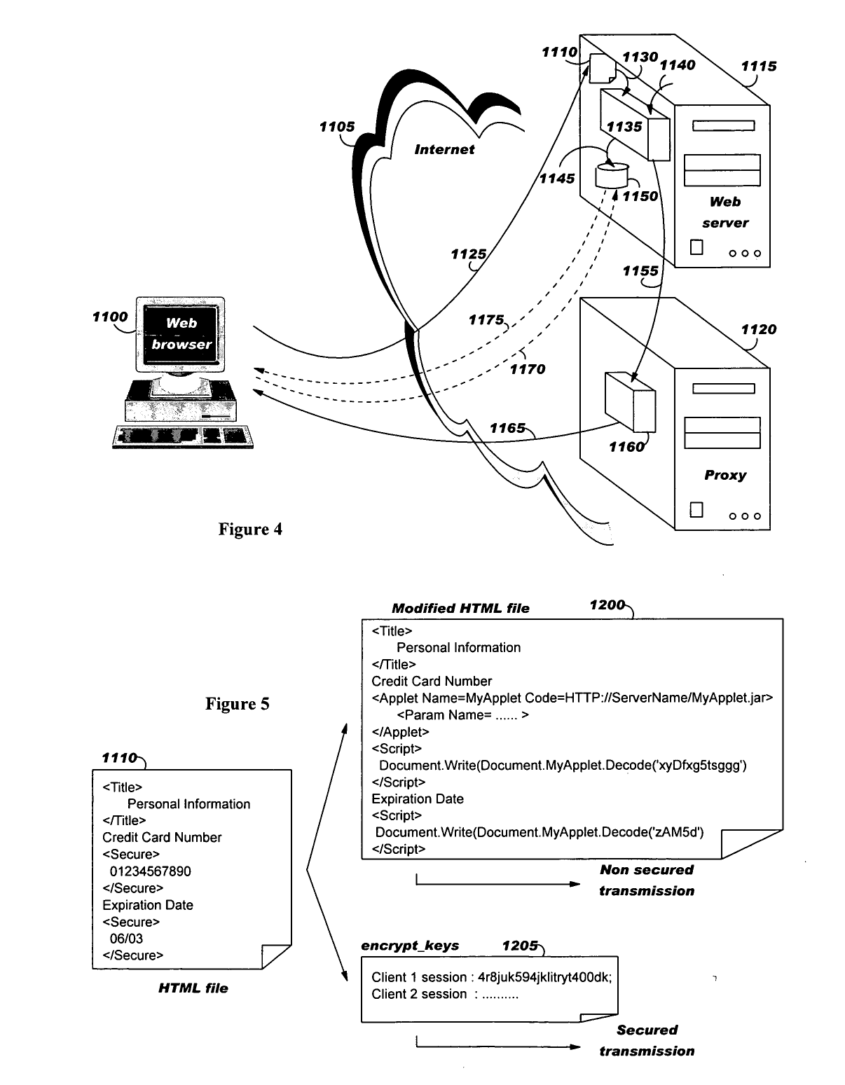

FIG. 4 illustrates the general principle of the method of this embodiment of the invention for transmitting documents containing proprietary information from servers to clients, over nonsecure networks. As shown, a Client Web Browser 1100, having an access to the Internet network 1105, may request a data file 1110 stored in a Web Server 1115. A proxy 1120, comprising a transcoding function, may be used to format the data file 1110 according to the Client device characteristics. Therefore, the Client Web Browser 1100 sends a request (1125) for a data file 1110 using a standard communication protocol, e.g., HTTP. Although the data file 1110 is stored in the Web Server 1115 in this example, it could naturally be stored in any other storage connected to the Internet network 1105. When the requested data file 1110 is available (1130) in the Web Server 1110, it is modified in module 1135 wherein proprietary data is encrypted using an encryption key (1140), e.g., a random key. The algorithm used to encrypt and decrypt proprietary data can be either a symmetric or an asymmetric algorithm. In a symmetric algorithm, the encryption key and the decryption key are the same. Examples of commonly used symmetric algorithms are Data Encryption Standard (DES) algorithm, Rivest-Cipher-4 (RC4) algorithm, and International Data Encryption Algorithm (IDEA). Asymmetric algorithms use two different keys, one for the encryption and the other for the decryption. Asymmetric algorithms, such as Rivest-Shamir-Adleman (RSA) algorithm and Digital Signature Algorithm (DSA) algorithm are particularly adapted for authentication tasks. In an embodiment of the invention, a symmetric algorithm is used and the common encryption/decryption key is locally stored (1145) in association with a client identifier. For example, the encryption/decryption key may be associated with the client session cookie and stored in a table 1150. A reference to the function for decrypting encrypted data is inserted in the data file. For sake of illustration, this function may be a Java Applet, locally stored on the Web Server.

After having extracted the proprietary data from the data file, module 1135 encrypts this proprietary data and inserts a call to a data insert function whose parameter is the decryption function, the parameter of the decryption function being the encrypted proprietary data. In the given example, the data insert function is of the form of a JavaScript while the decryption function is of the form of a Java Applet stored in the Web Server. Then, the modified data file is preferably transmitted (1155) to the proxy 1120 containing a transcoding module 1160, which can adapt the modified data file format to the client device characteristics. The adapted modified data file is then transmitted (1165) to the Client Web Browser 1100 where it can be displayed. As discussed above, the modified data file and the adapted modified data file are transmitted according to a standard communication protocol, e.g., HTTP.

When receiving the adapted modified data file, the above mentioned Java Applet is initialized when the Client Web Browser finds its reference. Initializing a Java Applet is directly handled by any Web Browser, and mainly comprises checking the presence of the code in the local cache and, if the code is not memorized in the local cache, in transferring the code from the Web Server. Then, when the script function for inserting data is analyzed, the decryption function, being the parameter of the data inserting function, is launched. A first step of the decryption function comprises determining if the requested decryption key is locally stored or not using, for example, an encrypt cookie that is set when the decryption key is transferred from the Web Server to the Client Web Browser. If the decryption key is not locally stored, it is transferred (1170 and 1175) from the web server where it is associated with a Client ID, using a secure communication protocol, e.g., HTTPS. Using this decryption key, the encrypted data may be decrypted and inserted in the file by the data insert function.

Thanks to the architecture presented on FIG. 4, it is not required to transmit the complete file with a secure protocol but only the decryption key. The whole file, wherein proprietary data is encrypted, is transmitted using a standard, nonsecure protocol. Therefore, the nonencrypted data may be adapted to the target device, as generally done, using, for example, a transcoding function like IBM Websphere Transcoding Publisher product (Websphere is a registered Trade Mark of International Business Machines Corporation). Furthermore, since an encryption key can be used to encrypt proprietary data of several files that have to be sent to a same client during the same session, the same decryption key can be used by the Client Web Browser, avoiding the need of accessing the Web Server each time a file containing proprietary data is requested.

FIG. 5 illustrates an example of the content of an HTML file before and after being modified. According to HTML format, tags are used in the data file 1110 to determine the data format. A dedicated tag, referred to as “<Secure>” in this example, and the corresponding ending tag (“</Secure>”) are used to delimit the proprietary data of the file. Naturally, several noncontiguous portions of the file may contain proprietary data. In the given example, the proprietary data corresponds to a credit card number and to the associated expiration date. To extract the proprietary data, analyzer module 1135 looks for the dedicated tags, “<Secure>” and </secure> in the given example. When these dedicated tags are found, they are removed and the data located between the tag <Secure> and the following corresponding ending tag </Secure> is extracted and encrypted. The reference of the Java Applet used for decrypting the data is inserted in the HTML file so that the corresponding code may be retrieved (from local cache or from the Web Server) during Java Applet initialization. A call to a data insert function is then inserted in the HTML file, as a JavaScript, for example. The parameter of this function is the decryption Java Applet whose parameter is the encrypted data. Therefore, when the data insert function is called, the decryption Java Applet is launched. As mentioned above, a cookie based mechanism may be used to determine whether or not the decryption key is locally available. If not, the Java Applet sends a request to the Web Server to receive the decryption key. There are as many calls to data insert functions as noncontiguous blocks of proprietary data. When the HTML file has been fully analyzed, all the proprietary data has been removed and replaced by calls to a data insert function. Therefore, the modified HTML file 1200 may be sent according to a nonsecure transmission protocol. As mentioned above, transmitting the modified HTML file according to a nonsecure transmission protocol allows a proxy to modify it, for example, to adapt it to the client device characteristics. The encryption/decryption keys are stored in association with a client ID, for example the encryption/decryption keys may be stored in table 1205, referred to as encrypt_keys, in association with client session ID as illustrated on FIG. 5. If an asymmetric encryption algorithm is used the encryption and the decryption keys are both memorized in table 1205, in association with client session ID. Naturally, only the decryption is transmitted to the Client Web Browser.

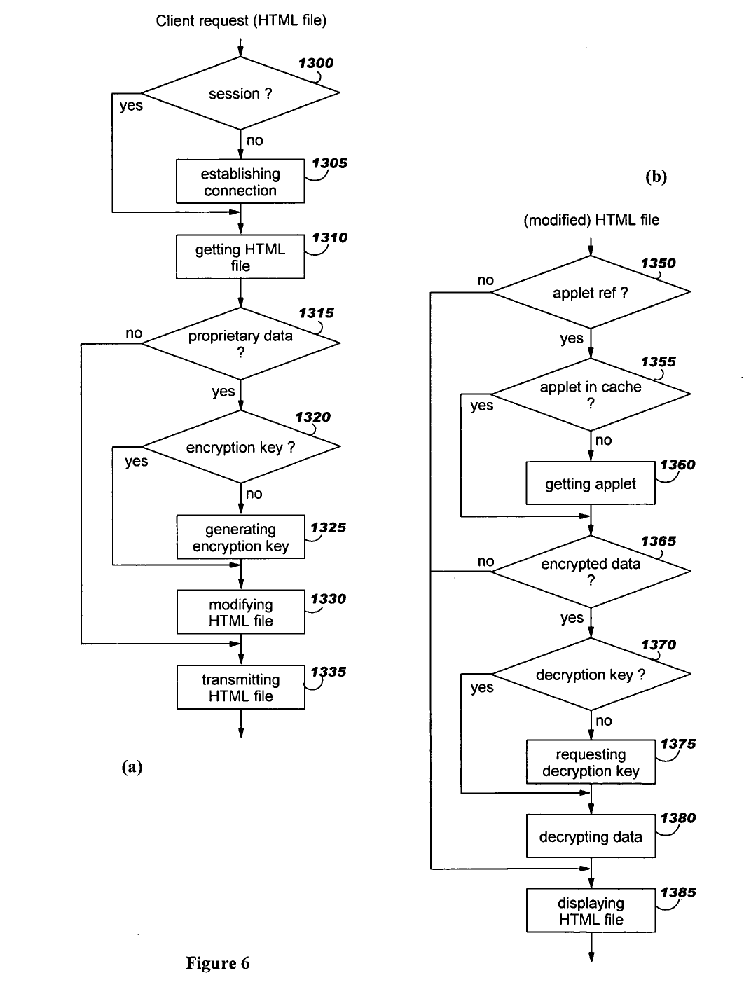

FIG. 6, comprising FIGS. 6a and 6b, shows an example of the global algorithm used to transmit files containing proprietary data between a Web Server and a Client Web Browser. FIG. 6a concerns the part of the algorithm that is handled by the Web Server, while FIG. 6b concerns the Client Web Browser part.

When the client sends a request to obtain an HTML page, the Web Server determines whether or not a session has already been established for this client (step 1300). For example, this test may comprise determining if a session cookie has been set or not for this client. If no session has been previously established, the connection is established (step 1305) and a session cookie may be transmitted to the Client Web Browser. Then, the Web Server gets the requested HTML file that may be locally stored or that may be stored in another connected server (step 1310). The HTML file is analyzed to determine whether or not it contains proprietary data that is detected with dedicated tags as described above (step 1315). If the HTML file does not contain proprietary data, it is transmitted to the Client Web Browser (step 1335). If the HTML file contains proprietary data, the Web Server checks if encryption/decryption keys have already been assigned to the client (step 1320). For example, this test may be done by checking a table wherein client session cookies are associated to assigned encryption/decryption keys. If there is no encryption/decryption key assigned to the client, the Web Server generates a random key (step 1325) and memorizes it in association with a client ID, e.g., the session cookie. When using an asymmetric encryption algorithm, the encryption key is randomly generated while the decryption key is computed from the encryption key. In such a case, both of them are memorized. Using the encryption key, proprietary data is encrypted and the HTML file is modified as described above (step 1330). Then, the modified HTML file is transmitted to the Client Web Browser (step 1335). As already discussed, the nonproprietary data of the modified HTML file may be adapted by a third-party system when the file is transmitted from the Web Server to the Client Web Browser.

When receiving an HTML file or a modified HTML file, the Client Web Browser checks for the presence of Java Applets (step 1350). If there is no Java Applet, the HTML file may be displayed as usually done (step 1385). Else, if there is a reference to a Java Applet, the Web Browser automatically checks if the corresponding code is locally stored in the cache memory or not (step 1355). If the Java Applet code is not locally stored in the cache memory, it is automatically downloaded from the Web Server (step 1360). Then, when analyzing the modified HTML file, the Client Web Browser determines if there is encrypted data (step 1365), i.e., if the decryption Java Applet is called. If there is no encrypted data, the HTML file may be displayed as usually done (step 1385). Else if there is encrypted data, the Client Web Browser checks whether or not the decryption key is locally stored (step 1370). To that end, the Client Web Browser may use, for example, a decryption key cookie that is set when the decryption key is transferred. If the decryption key is not locally available, the Client Web Browser sends a request to the Web Server to receive the required decryption key (step 1375). Naturally, these two steps (1370 and 1375) may be done during the Applet initialization phase, as illustrated with the following Java code. As mentioned above, the Web Server uses a Client ID, such as a client session cookie, and the table wherein encryption/decryption keys are stored to determine the correct decryption key that must be sent to the Client Web Browser. The request for the decryption key and the transmission of the decryption key are done according to a secure communication protocol, such as HTTPS. Using the decryption key the Java Applet can decrypt the encrypted data (step 1380) and the HTML file may be displayed as usually done (step 1385).

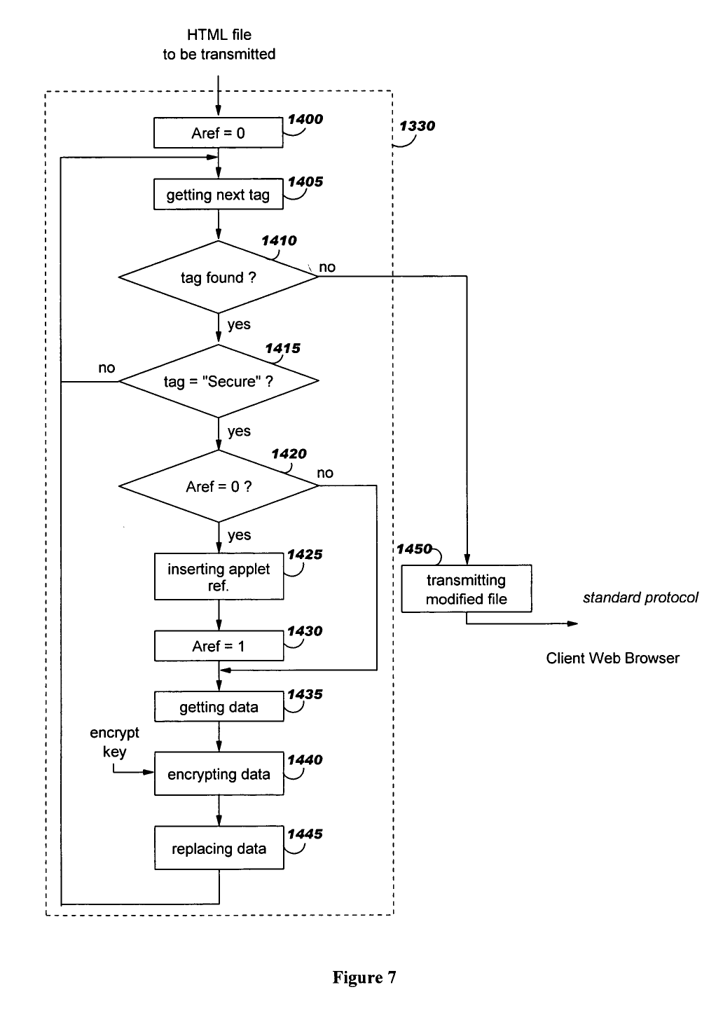

FIG. 7 depicts an example of the algorithm used for modifying an HTML file containing proprietary data. When the analyzer module 1135 receives the HTML file to be transmitted, a flag Aref is set to zero (step 1400). Flag Aref is used to determine whether or not the reference to the Java Applet used for decrypting encrypted data has been inserted in the modified HTML file. Then, according to the tag based protocol, the next tag is obtained (step 1405) and a test is performed to determine whether or not a tag has been found, i.e., whether or not the end of the file has been reached (step 1410).

If a tag is found, a second test is done to determine whether or not this tag indicates that the following data is proprietary (step 1415). If the tag does not indicate that following data is proprietary, the last two steps (steps 1405 and 1410) are repeated. Else, if the tag indicates that the following data is proprietary, a third test is performed to analyze the state of flag Aref (step 1420). If flag Aref is equal to zero, a reference to the Java Applet that is used to decrypt encrypted data is inserted in the HTML file (step 1425) and flag Aref is set to one (step 1430). The data located between the found tag and the following corresponding end tag is extracted (step 1435) and encrypted (step 1440). As mentioned above, the encryption key used to encrypt proprietary data is either obtained from a table if an encryption key has previously been assigned to the client (in the same session) or from an encryption key generator.

When proprietary data is encrypted, a call to a data insert function is included in the HTML file (step 1445). As already mentioned, this function call may be of the form of a JavaScript. The parameter of this function, i.e., the data that has to be inserted, is the result of a decryption function, such as a Java Applet, whose parameter is the encrypted data, as follows:
insert_data(decrypt_data(encrypted_data))
   wherein insert_data is a function that inserts data in an HTML file, and decrypt_data is a function that decrypts data and encrypted_data represents encrypted data.

Using JavaScript and Java Applet syntax, the previous example may be written as follow:
<Script>
Document.write(Document.myApplet.Decode(encrypted_data));
</Script>

After proprietary data is replaced by the call to data insert function (referred to as “Decode” in the given example), the last eight steps (steps 1405 to 1440) are repeated. If tag Aref is not equal to zero, the process is directly branch to step 1435 since the reference to the Java Applet used for decrypting encrypted data has already been inserted in the HTML file.

If no tag is found during step 1410, i.e., the end of the file has been reached, the modified HTML file is transmitted to the Client Web Browser that sent the request (step 1450). As mentioned above, the transmission of the modified HTML file is done according to a standard transmission protocol such as HTTP.

For sake of illustration, an example of Java code is given hereafter to illustrate the random encryption key generator and the decryption Java Applet.

Example of random encryption key generator based upon a symmetric encryption algorithm using DES:

try {

// Generate a DES key
KeyGenerator keyGen = KeyGenerator.getInstance(“DES”);
SecretKey key = keyGen.generateKey();

} catch (java.security.NoSuchAlgorithmException e) {...}

Example of decryption Java Applet:

import netscape.javascript.*;
import java.security.*;
public class TestCookie extends Applet
{
private String m_SharedSecretCookie = null;
JSObject m_Document = null;
SecretKey m_Key = null;
// this method retrieve a specified cookie (name).

private String getCookie(String name) {

// get a specific cookie by its name, parse the cookie.
String myCookie = Document.getMember(“cookie”);
String search = name + “=”;
if (myCookie.length( ) > 0) {

int offset = myCookie.indexOf(search);
if (offset != −1) {

offset += search.length( );
int end = myCookie.indexOf(“;”, offset);
if (end == −1) end = myCookie.length( );
myCookie.substring(offset,end);
}

else

System.out.println(“Did not find cookie: ”+name);
myCookie=“”;

}
return myCookie;
}

// standard init method of an applet where the applet is initialized

public void init( ) {

//Retrieve the Browser instance object to check the Shared Secret

cookie existence.

JSObject theBrowser = JSObject.getWindow(this);
m_Document = (JSObject) theBrowser.getMember(“document”);
theSharedSecretCookie = getCookie(“SharedSecret”);
if ((theSharedSecretCookie != null) && (theSharedSecretCookie.lenght >

0))

{

//Validate the Shared Secret cookie.
....
//retrieve on the local file system the DES encryption key file

(called “key.pub”).

DataInputStream in = new DataInputStream(new

FileInputStream(“key.pub”));

byte[ ] rawkey = new byte[(int)f.length( )];
In.readFully(rawkey);
In.close( );
// Convert the raw bytes to a secret key like this
DESKeySpec keyspec = new DESKeySpec(rawkey);
SecretKeyFactory keyfactory = SecretKeyFactory.getInstance(“DES”);

m_key = keyfactory.generateSecret(keyspec);

```
  }
  else
  {
// Request security acces right to the web brower
....
```

//OPEN an HTTPS cnx to retrieve the Shared Secret once per session
URL url = new URL(“https://” + ....);//HostName.
URLConnection conn = url.openConnection( );
// Retrieve the DES Key data flow from the HTTPS connexion

throught a GET method.

InputStream inStream = conn.getInputStream( );
byte [ ] byte_pub = new byte[pubfile.available( )];
inStream.read(byte_pub);
DESKeySpec keyspec = new DESKeySpec(byte_pub);
SecretKeyFactory keyfactory = SecretKeyFactory.getInstance(“DES”);

m_key = keyfactory.generateSecret(keyspec);

inStream.close( );
// Request security acces right to the web brower
....
//Store the Shared Secret (the Key retrieved from the server locally on

the file system.

// to be reused by other requests of the same HTTP session.
FileOutputStream fpub = new FileOutputStream(“key.pub”);
ObjectOutputStream opub = new ObjectOutputStream(fpub);
opub.writeObject(m_Key);
// and set the cookie for next requests.
// to use the locally stored key rather than retrieving the server key

at each request.

m_Document.setMember(“cookie”, “ShareSecret ......”);
.....
}

// This method is called by the Web browser using a Javascript contain in

the HTML page to decode on the fly the secured data encrypted.

public String Decode(String aCodedString) {

Cipher dcipher;
try {
dcipher = Cipher.getInstance(“DES”);
dcipher.init(Cipher.DECRYPT_MODE, m_key);
// Decode base64 to get bytes
byte[ ] dec = new sun.misc.BASE64Decoder( ) .decodeBuffer(aCodedString);
// Decrypt
byte[ ] utf8 = dcipher.doFinal(dec);
// Decode using utf-8
return new String(utf8, “UTF8”);
....
}
catch (IllegalBlockSizeException e) { }
catch (UnsupportedEncodingException e) { }
catch (java.io.IOException e) { }
return null;
}

Naturally, in order to satisfy local and specific requirements, a person skilled in the art may apply to the solution described above many modifications and alterations all of which, however, are included within the scope of protection of the invention as defined by the following claims.

1. A method for securely transmitting a tag based protocol file comprising proprietary data from a server to a client device, the method comprising the steps of:
identifying the proprietary data within the tag based protocol file,
extracting and storing locally the proprietary data;
inserting at least one reference to the locally stored proprietary data in the tag based protocol file to provide a modified tag based protocol file;
transmitting the modified tag based protocol file using a standard communication protocol; and,
upon request of the client device, transmitting the locally stored proprietary data according to a secure communication protocol, the request comprising the at least one reference to the locally stored proprietary data.

2. The method of claim 1, further comprising the step of inserting at least one call to a data insert function in the tag based protocol file, the parameters of the data insert function comprising the at least one reference to the locally stored proprietary data.

3. The method of claim 1, wherein the proprietary data is delimited by tags.

4. The method of claim 1, further comprising the step of inserting a path determining a location wherein the proprietary data is locally stored, the at least one reference being used in conjunction with the path.

5. The method of claim 2, wherein the at least one reference and the at least one call to a data insert function comprise a JavaScript.

6. The method of claim 1, wherein the tag based protocol file is selected from the group consisting of: a Hyper Text Markup Language (HTML) file and a Wireless Markup Language (WML) file.

7. An apparatus comprising means adapted for carrying out the method according to claim 1.

8. A computer readable medium comprising instructions for carrying out the method according to claim 1.

9. A method for securely transmitting a tag based protocol file comprising proprietary data from a server to a client device, the method comprising the steps of:
identifying the proprietary data within the tag based protocol file,
extracting and encrypting the proprietary data according to an encryption key;
inserting the encrypted proprietary data in the tag based protocol file;
transmitting the modified tag based protocol file using a standard communication protocol; and,
upon request of the client device, transmitting the decryption key corresponding to the encryption key, according to a secure communication protocol.

10. The method of claim 9, further comprising the step of inserting a call to a decryption function in the tag based protocol file, a parameter of the decryption function comprising the encrypted proprietary data.

11. The method of claim 9, further comprising the step of inserting a call to a data insert function in the tag based protocol file, the parameters of the data insert function comprising a call to a decryption function and the parameters of the decryption function comprising the encrypted proprietary data.

12. The method of claim 11, wherein the insert function is of the form of a JavaScript.

13. The method of claim 10, wherein the decryption function is of the form of Java Applet.

14. The method of claim 13, further comprising the step of inserting a path determining a location wherein code of the Java Applet is available.

15. The method of claim 9, wherein the proprietary data is delimited by tags.

16. The method of claim 9, wherein the tag based protocol file is selected from the group consisting of: a Hyper Text Markup Language (HTML) file and a Wireless Markup Language (WML) file.

17. An apparatus comprising means adapted for carrying out the method according to claim 9.

18. A computer readable medium comprising instructions for carrying out the method according to claim 9.
